(19) United States
(12) Patent Application Publication
(10) Pub. No.: US 2023/0232735 A1
(43) Pub. Date: Jul. 27, 2023

(54) POWER EQUIPMENT MACHINE WITH FOOT PEDAL STEERING AND SPEED CONTROLS

(71) Applicant: MTD PRODUCTS INC, Valley City, OH (US)

(72) Inventors: Jay Maggard, Polk, OH (US); Kenneth J. Maynard, Valley City, OH (US)

(21) Appl. No.: 18/101,797

(22) Filed: Jan. 26, 2023

Related U.S. Application Data
(60) Provisional application No. 63/303,058, filed on Jan. 26, 2022.

(51) Int. Cl. A01D 34/00; A01D 34/64

(52) U.S. Cl. CPC A01D 34/006; A01D 34/64; A01D 2101/00

(57) ABSTRACT

An outdoor power equipment with steering and/or speed controlled via foot-based inputs is discussed. One example embodiment is an outdoor power equipment, comprising: a frame; a plurality of drive elements coupled to the frame; a prime mover configured to provide power to the plurality of drive elements; one or more controls configured to receive foot-based inputs from an operator of the outdoor power equipment; and a control system configured to control a steering and a speed of the outdoor power equipment based on the foot-based inputs. Various foot-based embodiments and control systems can be employed based on the embodiment.

### CROSS-REFERENCE TO RELATED APPLICATION

This application for patent claims the benefit of priority from U.S. Provisional Patent Application No. 63/303,058 filed Jan. 26, 2022, which is hereby incorporated by reference herein in its entirety and for all purposes.

### FIELD OF DISCLOSURE

The disclosed subject matter pertains to apparatuses and methods for steering and/or speed/acceleration control for power equipment, for instance, systems and methods for foot-based steering and/or speed/acceleration of outdoor power equipment.

### BACKGROUND

Manufacturers of power equipment for outdoor maintenance applications offer many types of machines for general maintenance and mowing applications. Generally, these machines can have a variety of forms depending on application, from general urban or suburban lawn maintenance, rural farm and field maintenance, to specialty applications. Even specialty applications can vary significantly. For example, mowing machines suitable for sporting events requiring moderately precise turf, such as soccer fields or baseball outfields may not be suitable for events requiring very high-precision surfaces such as golf course greens, tennis courts and the like.

Modern maintenance machines also offer multiple options for steering and/or speed/acceleration. Depending on the power equipment, any of a variety of hand controls (or combined hand and foot controls) can be employed for steering and speed/acceleration. Lap bars, for example, are used on many outdoor power equipment for both steering and speed/acceleration. In some other outdoor power equipment, steering wheels can be employed (e.g., in connection with acceleration pedals, etc.).

### BRIEF SUMMARY

The following presents a simplified summary in order to provide a basic understanding of some aspects of the disclosure. This summary is not an extensive overview of the disclosure. It is not intended to identify key/critical elements or to delineate the scope of the disclosure. Its sole purpose is to present some concepts of the disclosure in a simplified form as a prelude to the more detailed description that is presented later.

Various embodiments of the present disclosure provide outdoor power equipment having foot-based controls for steering and/or acceleration of the outdoor power equipment. Depending on the embodiment, various types of control can be used, such as translating the motion and/or position (e.g., rotational and/or translational motion/position) of the foot-based controls into steering and/or acceleration, translating the pressure on the foot-based controls, etc. Various embodiments can employ differential steering based on independent control of the speed of left and right drive elements via left and right foot-based controls.

One example embodiment is an outdoor power equipment, comprising: a frame; a plurality of drive elements coupled to the frame; a prime mover configured to provide power to the plurality of drive elements; one or more controls configured to receive foot-based inputs from an operator of the outdoor power equipment; and a control system configured to control a steering and a speed of the outdoor power equipment based on the foot-based inputs.

To accomplish the foregoing and related ends, certain illustrative aspects of the disclosure are described herein in connection with the following description and the drawings. These aspects are indicative, however, of but a few of the various ways in which the principles of the disclosure can be employed and the subject disclosure is intended to include all such aspects and their equivalents. Other advantages and features of the disclosure will become apparent from the following detailed description of the disclosure when considered in conjunction with the drawings.

### BRIEF DESCRIPTION OF THE DRAWINGS

FIG. 1 illustrates a diagram of an example foot-based steering and/or speed/acceleration system that can be employed in an outdoor power equipment, according to various embodiments of the present disclosure.

FIG. 2 illustrates a side perspective view of example lawn maintenance apparatus, in connection with various aspects discussed herein.

FIG. 3 illustrates a rear view of example lawn maintenance apparatus, in connection with various aspects discussed herein.

FIG. 4 illustrates a top perspective view of example lawn maintenance apparatus, in connection with various aspects discussed herein.

FIG. 5 illustrates two close-up views of the rear of lawn maintenance apparatus, showing details of stand platform/controls, in connection with various aspects discussed herein.

FIG. 6 illustrates another two close-up views of the rear of lawn maintenance apparatus, showing details of stand platform/controls, in connection with various aspects discussed herein.

FIG. 7 illustrates two additional close-up views of the rear of lawn maintenance apparatus, showing details of stand platform/controls, in connection with various aspects discussed herein.

FIG. 8 illustrates a diagram of an example pressure-based embodiment of an outdoor power equipment controllable via foot-based controls, in connection with various aspects discussed herein.

It should be noted that the drawings are diagrammatic and not drawn to scale. Relative dimensions and proportions of parts of the figures have been shown exaggerated or reduced in size for the sake of clarity and convenience in the drawings. The same reference numbers are generally used to refer to corresponding or similar features in the different embodiments, except where clear from context that same reference numbers refer to disparate features. Accordingly, the drawings and description are to be regarded as illustrative in nature and not as restrictive.

While embodiments of the disclosure pertaining to machine vision systems for power equipment machines are described herein, it should be understood that the disclosed machines, electronic and computing devices and methods are not so limited and modifications may be made without departing from the scope of the present disclosure. The scope of the systems, methods, and electronic and computing devices for machine vision devices are defined by the appended claims, and all devices, processes, and methods that come within the meaning of the claims, either literally or by equivalence, are intended to be embraced therein.

### DETAILED DESCRIPTION

The following terms are used throughout the description, the definitions of which are provided herein to assist in understanding various aspects of the subject disclosure.

As used in this application, the terms “outdoor power equipment”, “outdoor power equipment machine”, “power equipment”, “maintenance machine” and “power equipment machine” are used interchangeably and are intended to refer to any of robotic, partially robotic ride-on, walk-behind, sulky equipped, autonomous, semi-autonomous (e.g., user-assisted automation), remote control, or multi-function variants of any of the following: powered carts and wheel barrows, lawn mowers, lawn and garden tractors, lawn trimmers, lawn edgers, lawn and leaf blowers or sweepers, hedge trimmers, pruners, loppers, chainsaws, rakes, pole saws, tillers, cultivators, aerators, log splitters, post hole diggers, trenchers, stump grinders, snow throwers (or any other snow or ice cleaning or clearing implements), lawn, wood and leaf shredders and chippers, lawn and/or leaf vacuums, pressure washers, lawn equipment, garden equipment, driveway sprayers and spreaders, and sports field marking equipment.

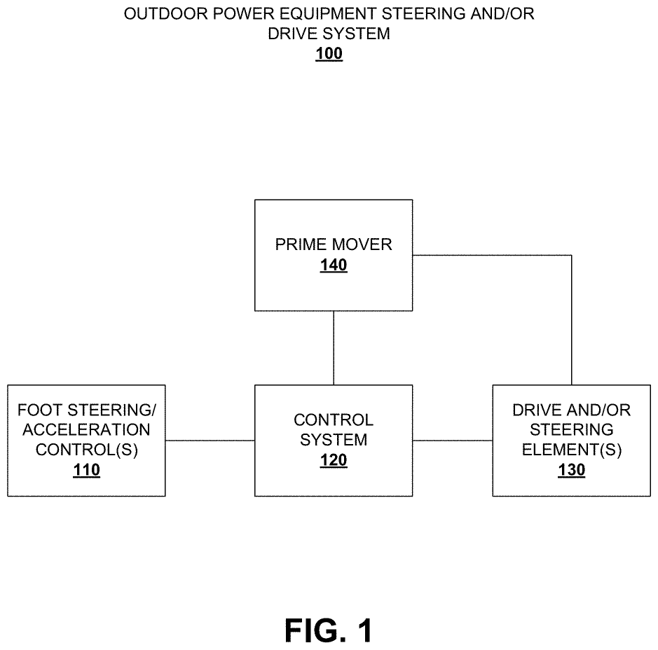

FIG. 1 illustrates a diagram of an example foot-based steering and/or speed/acceleration system 100 that can be employed in an outdoor power equipment, according to various embodiments of the present disclosure. System 100 can comprise foot steering and/or speed/acceleration controls 110 (e.g., a left pedal or other foot control and a right pedal or other foot control, etc.), a control system 120, drive and/or steering elements 130, and a prime mover 140. Controls 110 can allow an operator to provide any of a variety of foot-based controls (e.g., rotational and/or translational motion, pressure, etc.) that can be translated via control system 120 into steering (e.g., direction of motion or turn, etc.) and/or acceleration/speed controls for drive and/or steering element(s) 130 (e.g., wheel(s), track(s), etc.), which can be powered via prime mover 140 (e.g., an engine, battery, etc. that can power system 100 and/or the outdoor power equipment comprising system 100). Depending on the embodiment, system 100 and the components thereof can take a variety of forms, including but not limited to the example embodiments discussed below in connection with example lawn maintenance apparatus 200 and example outdoor power equipment 300.

For example, controls 110 can comprise a left control 110 and right control 110, each of which can be configured to receive a range of inputs, such as: varying amounts of pressure on pressure sensor(s) at the front and/or back of the control(s) 110 (e.g., more pressure at the front can be regarded as “forward,” while more pressure at the back can be regarded as “backward,” etc.), varying the angle of the control(s) 110 by rotating or tilting the controls “forward” (e.g., which can correspond to rotating such that a front or toe portion is lowered and a rear or heel portion is raised, etc.) and/or “backward” (e.g., which can correspond to rotating such that a front or toe portion is raised and a rear or heel portion is lowered, etc.), varying the position(s) of control(s) 110, etc.

In various embodiments, control system 120 can translate operator input(s) received via control(s) 110 into steering and speed/acceleration based on differential steering or skid steering. For example, a left (or right) control 110 can be coupled to left (or right) drive/steering element(s) 130 such that forward (or backward) input via left (or right) control 110 is translated via control system 120 into forward (or backward, respectively) motion of the left (or right, respectively) drive/steering element(s). Thus, for example, equal forward pressure, angle, motion, etc. on control(s) 110 can be translated by control system 120 into forward motion in a straight line with a speed/acceleration based on the extent of pressure/angle/motion/etc.; equal backward pressure, angle, motion, etc. on control(s) 110 can be translated by control system 120 into backward motion in a straight line with a speed/acceleration based on the extent of pressure/angle/motion/etc.; a difference in pressure, angle, motion, etc. on control(s) 110 can be translated by control system 120 into turning based on the extent of pressure/angle/motion/etc.

Depending on the specific embodiment, a variety of mechanisms can be employed by control system 120 to translate inputs from control 110 into steering and/or speed/acceleration controls for drive/steering element(s) 130, such as one or more of: mechanical (e.g., gearing, transmissions, etc. connecting control(s) 110 to drive/steering element(s) 130, etc.), electrical (e.g., sensor(s), transducer(s), etc. can translate operator input from control(s) 110 into electrical signal(s) that can be used by control system 120 to determine steering and/or speed/acceleration outputs for drive/steering element(s) 130, etc.), electromechanical, hydraulic, hydrostatic, pneumatic, etc.

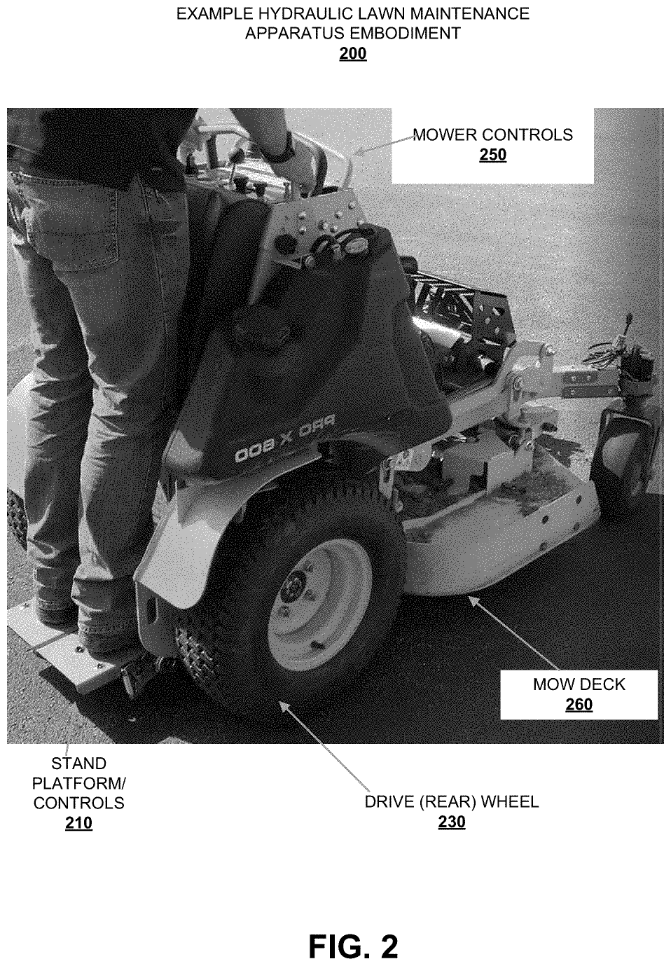

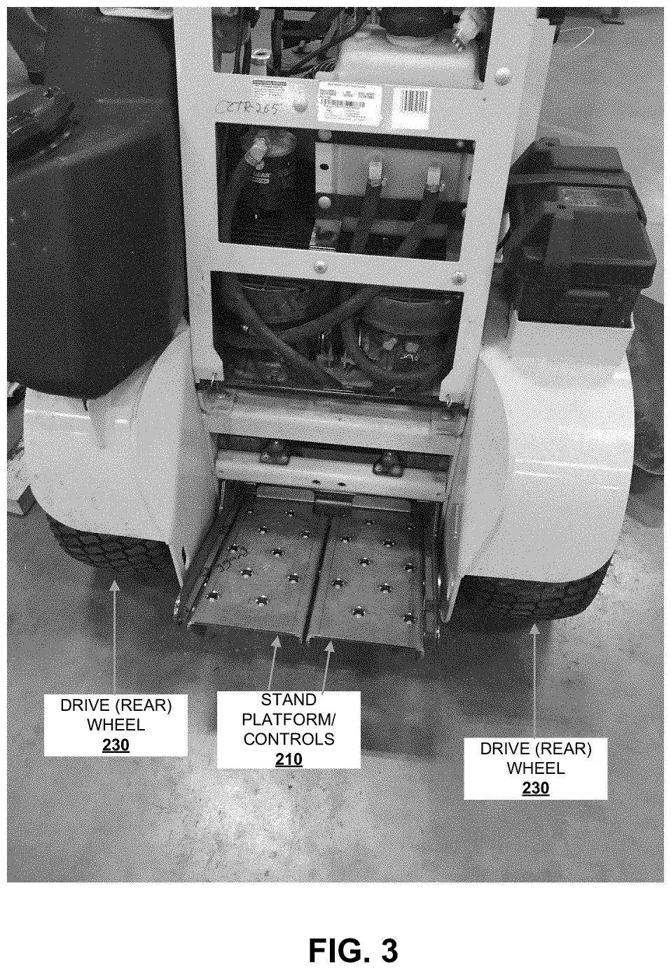

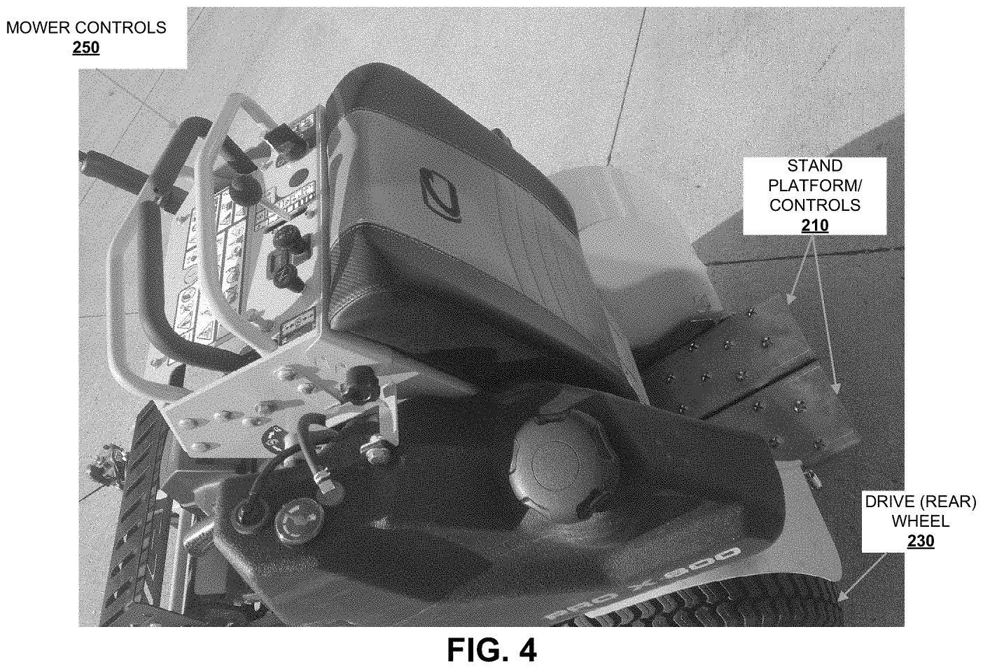

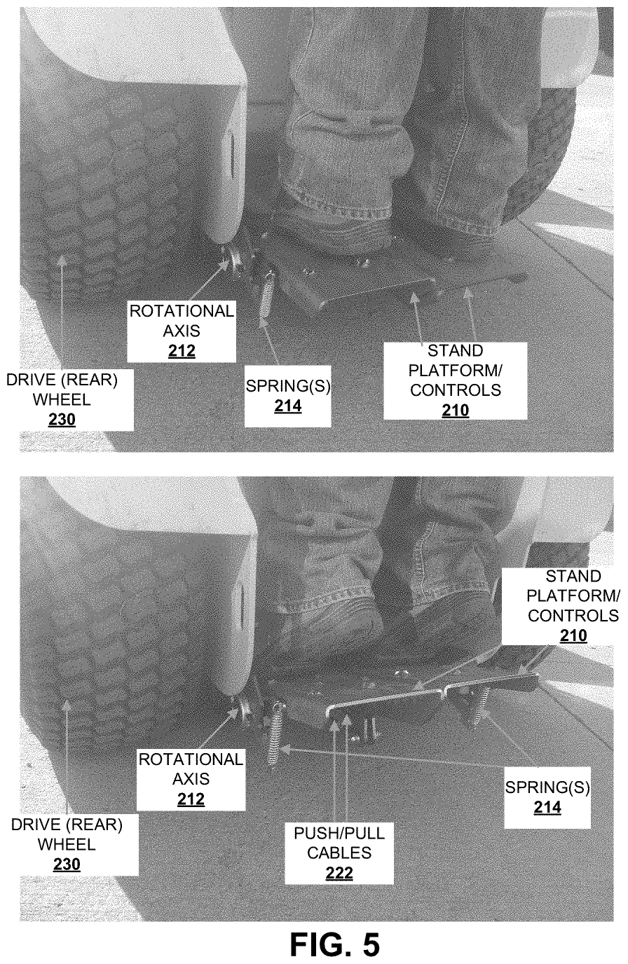

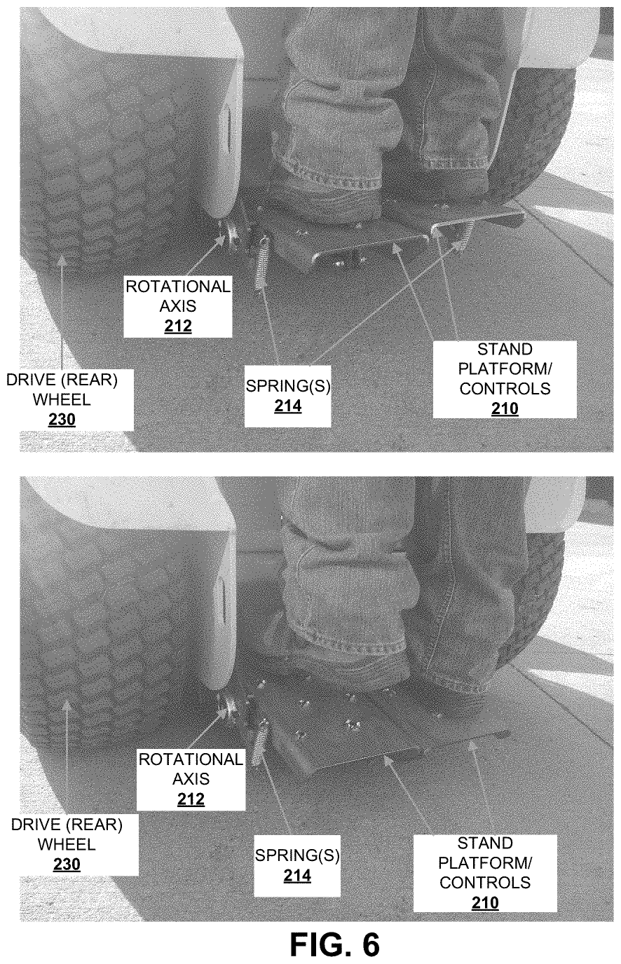

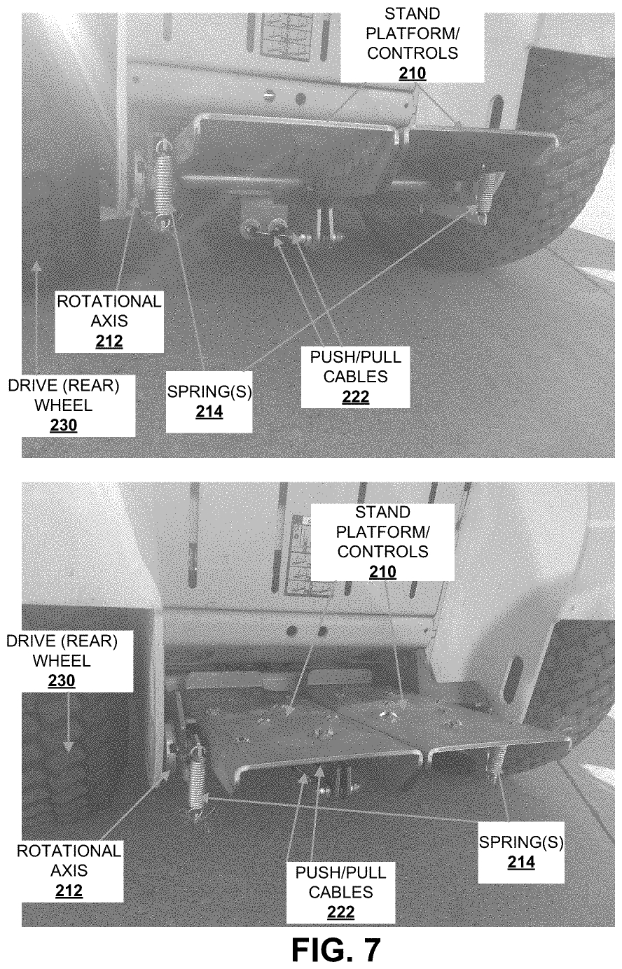

Turning to FIGS. 2-7, illustrated are various images of an example embodiment of a lawn maintenance apparatus 200 comprising one embodiment of a foot-based steering and/or speed/acceleration system, in connection with various aspects discussed herein. FIG. 2 shows a side perspective view of example lawn maintenance apparatus 200, in connection with various aspects discussed herein. FIG. 3 shows a rear view of example lawn maintenance apparatus 200, in connection with various aspects discussed herein. FIG. 4 shows a top perspective view of example lawn maintenance apparatus 200, in connection with various aspects discussed herein. FIG. 5 shows two close-up views of the rear of lawn maintenance apparatus 200, showing details of stand platform/controls 210, in connection with various aspects discussed herein. FIG. 6 shows another two close-up views of the rear of lawn maintenance apparatus 200, showing details of stand platform/controls 210, in connection with various aspects discussed herein. FIG. 7 shows two additional close-up views of the rear of lawn maintenance apparatus 200, showing details of stand platform/controls 210, in connection with various aspects discussed herein. While example apparatus 200 is a lawn maintenance apparatus, similar foot-based steering/speed/acceleration systems can be employed on other types of outdoor power equipment.

Lawn maintenance apparatus 200 can comprise a stand platform with steering/speed/acceleration controls 210, details of which can be seen in FIGS. 5-7. Lawn maintenance apparatus 200 can comprise a hydraulic control system (push/pull cables 222 of which can be seen in FIGS. 5 and 7) for distributing power to drive wheels 230, to provide for speed/acceleration and differential steering of lawn maintenance apparatus 200. Lawn maintenance apparatus 200 can also comprise mower controls 250 for operating various features of lawn maintenance apparatus 200, such as the operation and height of mow deck 260.

Stand platform/controls 210 can have features similar to many stand platforms on existing outdoor power equipment, allowing an operator to ride lawn maintenance equipment 200 in a standing position, while controlling steering and speed/acceleration via controls 210.

In existing standing lawn maintenance apparatuses, steering and speed/acceleration are operated by hand via lap bars. This prevents use of hands for other functions of the machine while navigating. Freeing-up the hands/arms can allow the driver to perform other functions, for example: engaging the cutting blades, changing the deck height, controlling other mower accessories, eating, drinking, using a cell phone, a friendly wave to a neighbor, etc. In various embodiments (e.g., lawn maintenance apparatus 200, outdoor power equipment 300, etc.), these functions can be performed without interruption of cutting and navigating.

Stand platform/controls 210 can be coupled to a suspension system (e.g., via rotational axis 212, etc.), which can be used to sense operator presence, improve operator comfort, reduce operator fatigue, and increase the accuracy of operator inputs via stand platform/controls 210 by reducing the effect of bumps, etc. on operator inputs.

An operator can apply more force at the front or rear of the left (or right) control 210 to rotate it forward or backward, respectively. This rotation can extend or compress, respectively, a push/pull cable 222 coupled to a swash plate of that control 210. In response to pushing or pulling push/pull cable 222 relative to a neutral position of control 210, the control system can cause the corresponding left (or right) drive wheel to drive forward or backward based on the extent to which the push/pull cable 222 is moved. Operation of both controls 210 can provide for speed/acceleration and differential steering of drive wheels 230, including zero turn capability (e.g., by pushing each control to opposite maximum positions, such as left forward and right backward for a right zero turn, or vice versa for a left zero turn, etc.).

Each control 210 can also be coupled to a corresponding spring 214 that can bias that control 210 toward its neutral position, such that in the absence of an operator affirmatively applying force to that control 210, it returns to the neutral position.

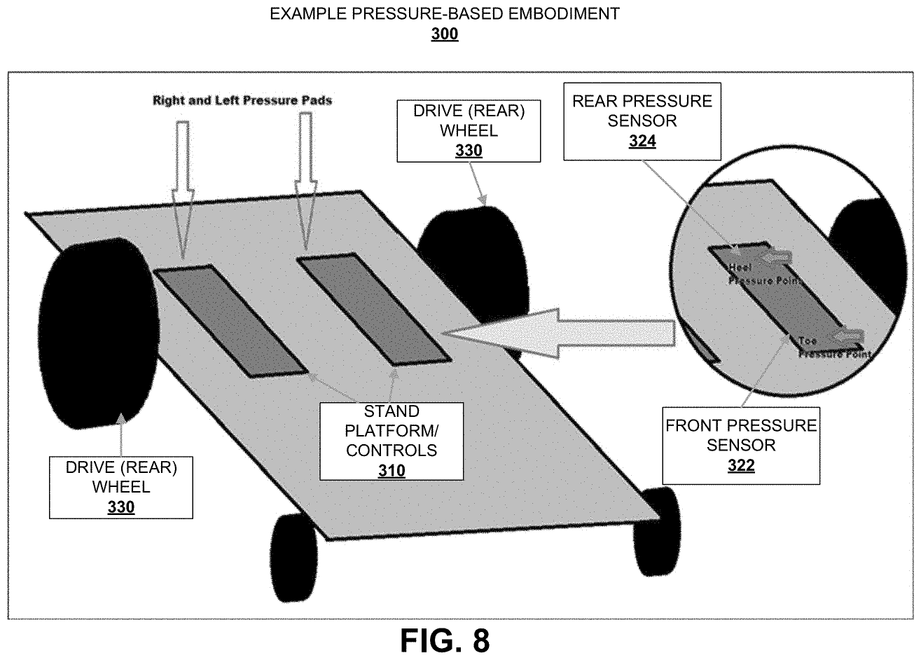

Referring to FIG. 8, illustrated is a diagram of an example pressure-based embodiment 300 of an outdoor power equipment controllable via foot-based controls, in connection with various aspects discussed herein. In example embodiment 300, stand platform/controls 310 and its associated control system can provide similar advantages and features to those of example embodiments 200, but can employ a different input method and control system.

Each of the left and right controls 310 can comprise a front (or toe) pressure sensor 322 and a rear (or heel) pressure sensor 324. Varying amounts of pressure can be applied by an operator to the pressure sensor(s) 322 and/or 324 of the left (or right) control 310 to control forward or backward motion of the left (or right, respectively) drive wheel 330, providing differential steering and speed/acceleration control via foot-based controls from an operator of embodiment 300.

In embodiment 300, pressure pads can be integrated into the foot space of both the right and left feet. Pressure sensors 322 and 324 (e.g., absolute pressure sensors for air-filled pads) can be installed at the front and rear of each pad. Applying a controlled amount of pressure to the toe (front) area of the pad can cause (e.g., via any of variety of mechanisms discussed herein in connection with control systems, such as electrical, electromechanical, etc.) rotation of the associated wheel 330 in the forward rotation at a velocity proportional to that pressure, while applied. Similarly, applying pressure to the heel (rear) area can control a reverse velocity of the associated wheel 330. As with embodiment 200, differential steering can be accomplished by varying operator inputs between left and right controls 310, functionally replacing lap bars, and freeing operator hands for other activities (e.g., operating other features of outdoor power equipment 300, such as PTO (power take-off) engagement, etc.).

Although embodiments 200 and 300 are provided as specific example embodiments showing specific implementations of controls 110, control system 120, etc., various embodiments can employ other specific implementations. For example, strain gauge(s), MEMS (microelectromechanical system) accelerometer(s), etc. can be employed to translate operator inputs via foot-based controls into steering and/or speed outputs via drive wheel(s).

While example embodiments discussed herein comprise left and right controls, which can control left and right drive wheels/tracks/etc. via one-dimensional controls (e.g., extent of pressure/rotation/etc. forward or backward, etc.), other embodiments are also possible, such as a single control that can receive inputs from which steering and speed/acceleration can be determined (e.g., for an example pressure-based embodiment, the net left/right pressure/etc. difference can determine steering angle and the net forward/backward pressure/etc. difference can determine speed or acceleration, etc.).

Additionally, although example embodiments 200 and 300 are configured to be operated by a standing operator, other steering and/or drive system embodiments can be employed in outdoor power equipment configured to be operated by a seated operator.

In regard to the various functions performed by the above described components, machines, devices, processes and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In this regard, it will also be recognized that the embodiments include a system as well as electronic hardware configured to implement the functions, or a computer-readable medium having computer-executable instructions for performing the acts or events of the various processes.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In other embodiments, combinations or sub-combinations of the above disclosed embodiments can be advantageously made. Moreover, embodiments described in a particular drawing or group of drawings should not be limited to those illustrations. Rather, any suitable combination or subset of elements from one drawing(s) can be applied to other embodiments in other drawings where suitable to one of ordinary skill in the art to accomplish objectives disclosed herein, known in the art, or reasonably conveyed to one of ordinary skill in the art by way of the context provided in this specification. Where utilized, block diagrams of the disclosed embodiments or flow charts are grouped for ease of understanding. However, it should be understood that combinations of blocks, additions of new blocks, re-arrangement of blocks, and the like are contemplated in alternative embodiments of the present disclosure.

Based on the foregoing it should be understood that the examples and embodiments described herein are for illustrative purposes only and that various modifications or changes in light thereof will be suggested to persons skilled in the art and are to be included within the spirit and purview of this application and scope of the appended claims.

What is Claimed is:

1. An outdoor power equipment, comprising:
a frame;
a plurality of drive elements coupled to the frame;
a prime mover configured to provide power to the plurality of drive elements;
one or more controls configured to receive foot-based inputs from an operator of the outdoor power equipment; and
a control system configured to control a steering and a speed of the outdoor power equipment based on the foot-based inputs.

2. The outdoor power equipment of claim 1, wherein the one or more controls comprise a left control and a right control.

3. The outdoor power equipment of claim 2, wherein the plurality of drive elements comprises one or more left drive elements and one or more right drive elements, wherein the control system is configured to control a left speed of the one or more left drive elements based on foot-based inputs received via the left control, wherein the control system is configured to control a right speed of the one or more right drive elements based on foot-based inputs received via the right control, and wherein the steering and the speed of the outdoor power equipment are based on the left speed and the right speed.

4. The outdoor power equipment of claim 1, wherein the one or more controls are configured to be operated by the operator in a standing position.

5. The outdoor power equipment of claim 1, wherein the one or more controls are coupled to a suspension system.

6. The outdoor power equipment of claim 1, wherein the foot-based inputs comprise rotations of the one or more controls.

7. The outdoor power equipment of claim 6, further comprising one or more mechanisms to bias each control of the one or more controls to a neutral position of that control.

8. The outdoor power equipment of claim 1, wherein the foot-based inputs comprise pressures applied to the one or more controls.

9. The outdoor power equipment of claim 1, wherein the control system is one or more of mechanical, electrical, electromechanical, hydraulic, hydrostatic, or pneumatic.

10. The outdoor power equipment of claim 1, wherein the plurality of drive elements are one of a plurality of wheels or a plurality of tracks.

11. The outdoor power equipment of claim 1, wherein the outdoor power equipment is a lawn maintenance apparatus.
